(19) United States
(12) Patent Application Publication
(10) Pub. No.: US 2006/0291384 A1
(43) Pub. Date: Dec. 28, 2006

(54) System and method for discarding packets

(76) Inventors: John M. Harris, Chicago, IL (US); Ronald T. Crocker, St. Charles, IL (US); Joseph R. Sullivan, Plainfield, IL (US); Yehezkel Halifa, Herzelia (IL); Lizi Patlajan, Haifa (IL); Fei Xiong, Arlington Heights, IL (US)

Correspondence Address: MOTOROLA, INC., 1303 EAST ALGONQUIN ROAD, IL01/3RD, SCHAUMBURG, IL, 60196, US

(21) Appl. No.: 11/169,204

(22) Filed: Jun. 28, 2005

(51) Int. Cl. H04L 1/00

(52) U.S. Cl. 370/229

(57) ABSTRACT

A call where a packet discard policy (132) should be applied is selectively identified based upon a received property associated with the call. The packet discard policy (132) is applied to the selected call in order to selectively discard packets (134) associated with the call when a triggering event (136) occurs.

### FIELD OF THE INVENTION

The field of the invention relates to routing communications through networks and, more specifically, to routing communications to particular mobile stations within these networks.

### BACKGROUND OF THE INVENTION

Different types of information are sent through wireless networks. Transmission procedures often require that this information is transmitted and re-transmitted until it reaches the intended user. Retransmission attempts are undertaken to ensure that packets eventually reach the user and are not lost somewhere within the network.

However, during the transmission and/or retransmission of data, events occur that render the information irrelevant to the target user. For instance, the target user may become busy or unavailable due to various processes that are operating at the target. In another example, the target user may reject a call from an originator or turn off their mobile station.

In these situations, problems occur if irrelevant data is sent to or attempted to be sent to the target user. For example, sending irrelevant information tends to block other services or calls, wastes capacity in the system, reduces the battery life of mobile stations, and can confuse the listener if irrelevant packets are presented to the listener together with relevant packets.

Previous approaches sometimes attempted to purge or discard packets in networks for various reasons. However, these previous approaches did not trigger packet discard because of events that occurred during the call that rendered the packets irrelevant to a target user. Consequently, previous systems attempted to transmit irrelevant packets of various types to target users causing delays, consuming system resources, and creating inefficiencies within the network.

### BRIEF DESCRIPTION OF THE DRAWINGS

FIG. 1 is a block diagram of a system for discarding packets according to the present invention;

FIG. 2 is a call flow diagram for discarding packets according to the present invention;

FIG. 3 is a block diagram of another approach for discarding packets according to the present invention; and

FIG. 4 is a call flow diagram of another approach for discarding packets according to the present invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION OF THE PREFERRED EMBODIMENTS

A system and method that discards irrelevant packets to be delivered to a mobile station in a network is described. The approaches described herein avoid delivery of irrelevant packets to mobile stations thereby reducing delays, freeing system resources, and promoting efficiency within the network.

In many of these embodiments, a call for which a packet discard policy should be applied is selectively identified based upon a received property associated with the call. The packet discard policy is applied to the selected call in order to selectively discard packets associated with the call when a triggering event occurs.

The received property may be a property of at least one packet associated with the call such as the type of the packet (e.g., an audio packet type or a control packet type). In another example, the received property may be a Quality-of-Service (QoS) type indication associated with the call. For example, the QoS indication may be a life time of a flow associated with a packet associated with the call or an indication that the packet should be discarded when a target mobile station is busy. In another example, the received property may be related to an air interface messaging sequence associated with the call. For example, this information may identify that at least one packet associated with the call should be immediately discarded.

In others of these embodiments, call control packets are identified in the call and selected ones of these call control packets are dropped after the discard policy is applied. In one example of this approach, a first call control packet and subsequent duplicates of the first call control packet are identified and the subsequent duplicates of the first call control packet are discarded after application of the discard policy. The call control packets may be packets that are created in response to packets generated within a communication infrastructure.

The triggering event may also take a variety of forms. For example, the triggering event may be a busy indication being received from a target mobile station or the infrastructure associated with the target mobile station, audio packets being received that are late, a higher priority call being received, a server indicating a desire to discard packets in a flow, or a target mobile station being identified as available via some alternate wireless technology. Other examples of triggering events are possible.

Thus, approaches are described that eliminate or substantially reduce the amount of outdated or irrelevant packets sent to mobile stations. Since unnecessary packets are not delivered to the mobile stations, valuable system resources are conserved. In addition, delays resulting from the unneeded transmissions are reduced or eliminated and general network efficiency is promoted.

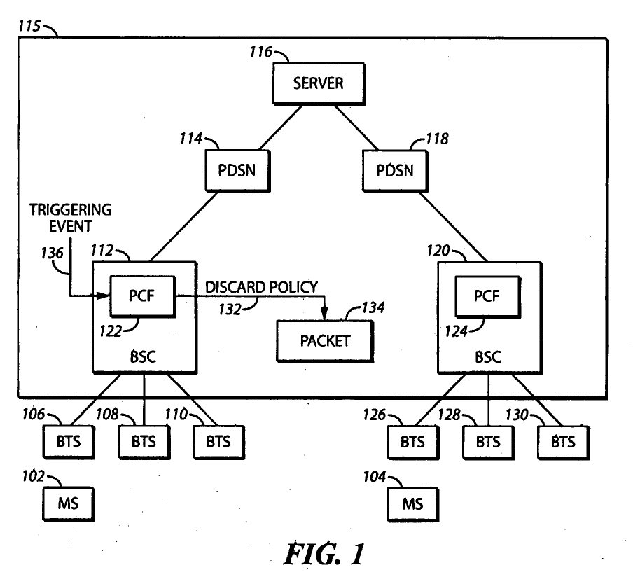

Referring now to FIG. 1, mobile stations 102 and 104 operate so as to be communicatively coupled to any of the Base Transceiver Sites (BTSs) 106, 108, 110, 126, 128, and 130. The mobile stations 102 and 104 may be any type of wireless device. For instance, the mobile stations 102 and 104 may be cellular telephones, pagers, personal computers, or personal digital assistants. Other examples of mobile stations are possible. The BTSs 106, 108, 110, 126, 128, and 130 include equipment that enables the mobile stations 102 and 104 to communicate with other elements of the system. For example, the BTSs 106, 108, 110, 126, 128, and 130 may include base stations, transmitters, and receivers that allow communications to be transmitted and received. A telecommunication infrastructure 115 may include the BSCs 112 and 120 (with the PCFs 122 and 124), the PDSNs 114 and 118 and the server 116.

The system of FIG. 1 may operate according to any number of protocols. For instance, messages may be exchanged between system elements according to the Session Initiation Protocol (SIP). However, it will be understood that other protocols or SIP-compliant protocols may be used in addition or in place of the SIP protocol.

The BTSs 106, 108, and 110 are connected to a Base Station Controller (BSC) 112 and the BTSs 126, 128, and 130 are connected to a BSC 120. The BSCs 112 and 120 are responsible for controlling the operation of the BTSs and for routing communication to other network elements. In this regard, the BSCs 112 and 120 include Packet Control Functions (PCFs) 122 and 124. As described elsewhere in this specification, the PCFs are responsible for identifying calls where a packet discard policy can be applied and applying the policy to the calls to drop packets once the appropriate calls have been identified. However, it will be realized that although these functions are described herein as being implemented at the PCFs 122 and 124, the functions can alternatively be implemented at other elements within the infrastructure 115 or among multiple elements of the infrastructure 115.

The BSCs 112 and 120 are connected to Packet Data Serving Nodes (PDSNs) 114 and 118. The PDSNs 114 and 118 in turn are coupled to a server 116, which switches information between the PDSNs 114 and 118. The server 116 may also perform other functions such as accounting and security functions.

In one example of the operation of the system of FIG. 1, a call between the mobile station 102 (the originating mobile station) and the mobile station 104 (the target mobile station) where a packet discard policy 132 should be applied is selectively identified based upon a received property associated with the call. The packet discard policy 132 is then applied to the selected call in order to selectively discard packets 134 associated with the call when a triggering event 136 occurs.

The received property is obtained by the PCF 122 or 124. For example, the PCF 122 or 124 may monitor messages or message flows for certain types of information. In other examples, the PCF 122 or 124 may receive other types of information from other entities such as SIP CANCEL or SIP BYE packets from the server 116.

The received property may be a property of at least one packet associated with the call such as a type of the at least one packet (e.g., an audio packet type and a control packet type). In another example, the received property may be a Quality-of-Service (QoS) type indication associated with the call. For example, the QoS indication may be a life time of a flow associated with at least one packet associated with the call or an indication that the at least one packet should be discarded when the target mobile station 104 is busy. In another example, the received property may be related to an air interface messaging sequence associated with the call. For example, this property may include an identifier indicating that a packet associated with the call that should be immediately discarded. In still another example, spam or telemarketer-related information may be identified by the type or content of the packets received.

In others of these embodiments, call control packets are identified in the call and selected ones of the call control packets are dropped after the discard policy is applied. In one example of this approach, a first call control packet and subsequent duplicates of the first call control packet are identified and the subsequent duplicates of the first call control packet are discarded after application of the discard policy. The call control packets may be packets that are created in response to packets generated within the communication infrastructure 115. For example, duplicate INVITE or ACK packets may be dropped.

The triggering event may also take a variety of forms. For example, the triggering event may be a busy indication being received from a target mobile station 104, audio packets being received from the mobile station 102 that are late, a higher priority call being received from another mobile station (not shown) by the PCF 122 or 124, the server 116 indicating a desire to discard packets in a call or flow, or the target mobile station 104 being identified as available via an alternate wireless technology.

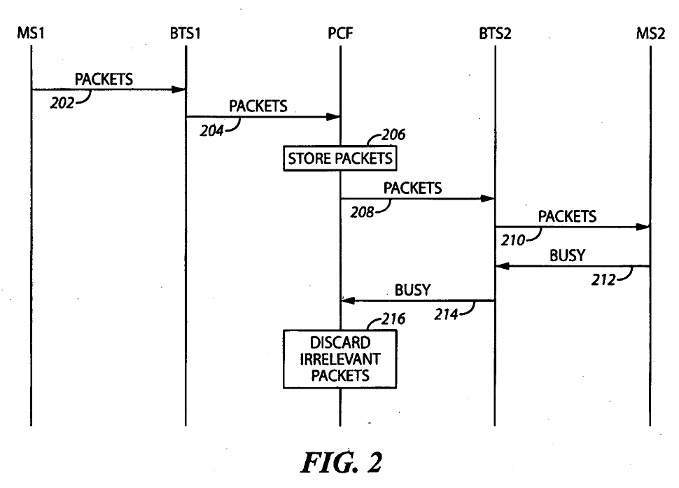

Referring now to FIG. 2, one example of an approach for identifying and discarding irrelevant packets in a network is described. At step 202, a first group of packets is sent from a first mobile station (MS1) to a first Base Transceiver Site (BTS1). The first Base Transceiver Site (BTS1) forwards the packets to a Packet Control Function (PCF) at step 204. At step 206, the packets are stored at the Packet Control Function (PCF) for later transmission. It will be understood that the packets represented in the steps in FIG. 2, are actually multiple packets that are transmitted over time. Thus, some packets may leave the first mobile station (MS1) even as others have been stored at the Packet Control Function (PCF) and still others have reached the second mobile station (MS2).

At step 208, some of the packets may be sent to a second BTS (BTS2) and, at step 210, from the second BTS (BTS2) to a second mobile station (MS2). At step 212, a busy indication is sent from the second mobile station (MS2) to the second BTS (BTS2) and at step 214 from the second BTS (BTS2) the Packet Control Function (PCF).

At step 216, it is determined whether to discard packets. In this case, it is determined whether the call is a candidate to having a discard algorithm applied, and if it is, the discard algorithm is applied once a triggering event occurs. For example, the system may examine the type packet (e.g., an audio packet type and a control packet type) to determine whether a policy should be applied. In another example, the system may examine a Quality-of-Service (QoS) type indication associated with the call. For example, the QoS indication may be a life time of a flow associated with at least one packet associated with the call or an indication that the packet should be discarded when a target mobile station is busy. In another example, the system may examine the air interface messaging sequence associated with the call. For example, this may include identifying that at least one packet associated with the call should be immediately discarded. Other types of received call properties may also be examined. In this case, it is determined that the call is a candidate for application of the discard policy.

Still at step 216, once it is determined whether to apply the policy, the system waits for a triggering event to occur in order to apply the policy. In this case, the triggering event is receipt of the busy indication from a mobile station. Other examples of triggering events include audio packets being received that are late, a higher priority call being received, a server indicating a desire to discard packets in a flow, or a target being identified as available via an alternate wireless technology.

As with the approaches described with respect to FIG. 1, the approaches described in FIG. 2 are described as utilizing SIP or a SIP-compliant protocol. However, it will be understood that other protocols may be used in addition or in place of the SIP protocol.

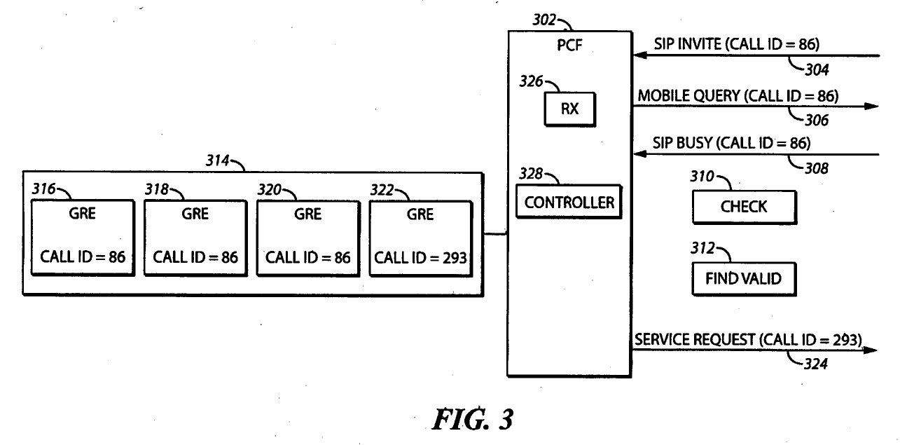

Referring now to FIG. 3, another example of an approach for discarding irrelevant packets in a network is described. At step 304 a Packet Control Function (PCF) 302 receives a SIP INVITE for mobile station 1234 with a call identifier of 86. At step 306, the PCF 302 issues a service request message to determine if packets can be sent to the mobile station having identifier 1234 can occur. At step 308, a response message to the query message is received indicating the mobile station having identifier 1234 is busy and no packets can be sent. As with the approaches related to FIGS. 1 and 2, the approaches described in FIG. 3 are described as utilizing SIP or a SIP-compliant protocol. However, it will be understood that other protocols may be used in addition or in place of the SIP protocol.

At step 310, the PCF 302 checks a memory or buffer 314 to determine if there are duplicate control packets. For instance, the memory or buffer 314 includes Generic Routing Encapsulation (GRE) packets 316, 318, and 320 having call identifiers 86. The packets 316, 318, and 320 are duplicates of the SIP INVITE 304, so the packets 316, 318, and 320 are discarded by the PCF 302. At step 312, the PCF 302 attempts to find any valid packets that are not duplicates. However, the packet 322 is a SIP INVITE packet for mobile station 1234 and has a call identifier 293 that is unique from the call identifier 86. Since the PCF 302 has identified a valid (i.e., non-duplicate) packet, the PCF 302 issues a service request with a call identifier of 293 at step 324. In one example, the service request may be a A9 BS Service Request message.

The PCF 302 includes a receiver 326 and a controller 328. The controller 328 is programmed to receive a plurality of packets associated with a call (e.g., the SIP INVITE packet at step 304) at the input of the receiver 326. After the packets are received, the controller 328 is programmed to determine whether the call is in need of application of the packet discard policy. As discussed elsewhere in this specification, this determination is based upon information received at the receiver 326. The controller 328 also receives a trigger event at the input of the receiver 326 and, responsively, to applies the packet discard policy to the call (e.g., applying step 310) in order to selectively discard at least some of the plurality of packets associated with the call (e.g., packets 316, 318, and 320) since these packets are duplicates. Other discard policies that are based upon other criteria are possible.

Conveniently, the approaches described with respect to FIG. 3 prevent the PCF 302 from issuing a SIP response for an expired INVITE when a response was already sent (e.g., in the form of a SIP 486 BUSY HERE or SIP 200 OK message). In addition, these approaches prevent duplicate SIP responses from being sent. For instance, once a Push-To-Talk (PTT) application server receives a SIP 486 BUSY HERE message, it will track addition responses being sent. Consequently, the PTT application server does not waste system or its own resources.

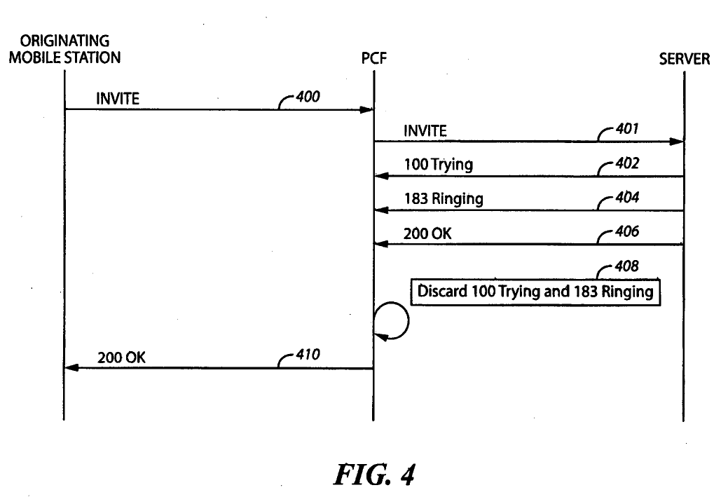

Referring now to FIG. 4, another example of an approach for discarding irrelevant packets is described. In this approach, a PCF discards interim responses when these interim responses are overridden by a subsequent response or responses. It will be understood that the approach described in FIG. 4 is only one example and the exact messages, responses, and identities of discarded messages may change depending upon the protocol used and the call circumstances.

At step 400, a user pushes a Push-to-Talk (PTT) button an INVITE message is sent to the PCF. At step 401, the INVITE is sent to the server. At step 402, the PCF receives a 100 Trying message indicating the server is processing the INVITE message. At step 404, a 183 Ringing message is received, which indicates to the originator it is acceptable to proceed with the call. The target then answers, and at step 406, a 200 OK message is received. Since the 200 OK message overrides the 100 Trying and 183 Ringing messages, the 100 Trying and 188 Ringing messages are discarded at step 408. At step 410, the 200 OK message is sent to the originator. Consequently, irrelevant messages (i.e., the 100 Trying message and the 183 Ringing message) are discarded before they are sent.

Thus, approaches are described that eliminate or substantially reduce the amount of outdated or irrelevant packets sent to mobile stations. Since the unnecessary packets are not delivered to the mobile stations, valuable system resources are not consumed. In addition, delays resulting from the unneeded transmissions are reduced or eliminated and general network efficiency is promoted.

Those skilled in the art will recognize that a wide variety of modifications, alterations, and combinations can be made with respect to the above described embodiments without departing from the spirit and scope of the invention, and that such modifications, alterations, and combinations are to be viewed as being within the scope of the invention.

What is claimed is:

1. A method for enabling fast and efficient Push-to-Talk (PTT) service in a network comprising:
selectively identifying a call where a packet discard policy should be applied based upon a received property associated with the call; and
applying the packet discard policy to the selected call in order to selectively discard packets associated with the call when a triggering event occurs.

2. The method of claim 1 wherein selectively identifying the call comprises identifying a property of at least one packet associated with the call.

3. The method of claim 2 wherein identifying the property of the at least one packet comprises identifying a type of the at least one packet.

4. The method of claim 3 wherein identifying the type of the at least one packet comprises identifying a type of the at least one packet selected from a group comprising: an audio packet type and a control packet type.

5. The method of claim 1 wherein identifying the call comprises identifying a Quality-of-Service (QoS) type indication associated with the call.

6. The method of claim 5 wherein identifying the QoS indication comprises identifying a characteristic selected from a group comprising: a life time of a flow associated with at least one packet associated with the call; and an indication that the at least one packet should be discarded when a target mobile station is busy.

7. The method of claim 1 wherein identifying the call comprises identifying a property of an air interface messaging sequence associated with the call.

8. The method of claim 7 wherein identifying a property of the air interface messaging sequence comprises identifying that at least one packet associated with the call should be immediately discarded.

9. The method of claim 1 wherein identifying the call further comprises identifying call control packets and wherein applying the packet discard policy further comprises dropping selected ones of the call control packets.

10. The method of claim 9 wherein identifying the call comprises identifying a first call control packet and subsequent duplicates of the first call control packet and wherein applying the packet discard policy comprises discarding the subsequent duplicates of the first call control packet.

11. The method of claim 9 wherein identifying call control packets comprises identifying packets that are response to packets generated within a communication infrastructure.

12. The method of claim 1 wherein applying the packet discard policy comprises applying the policy when a triggering event occurs, the triggering event being selected from a group comprising: a busy indication being received from a target mobile station; audio packets being received that are late; a higher priority call being received; a server indicating a desire to discard packets in a flow; and a target being identified as available via an alternate wireless technology.

13. The method of claim 1 wherein applying the packet discard policy comprises identifying and discarding at least one interim packet.

14. A method for discarding packets comprising:
within a cellular infrastructure:
receiving a plurality of packets associated with an ongoing call;
selectively identifying whether the ongoing call should have a packet discard policy applied based upon a property associated with the ongoing call;
detecting a triggering event; and
applying the packet discard policy to the ongoing call to selectively discard some of the plurality of packets associated with the ongoing call whenever the triggering event occurs.

15. The method of claim 14 wherein selectively identifying whether the ongoing call should have the packet discard policy applied comprises identifying a property of at least one packet of the plurality of packets associated with the ongoing call.

16. The method of claim 14 wherein selectively identifying whether the ongoing call should have the packet discard policy applied comprises identifying a Quality-of-Service (QoS) type indication associated with the ongoing call.

17. The method of claim 14 wherein selectively identifying whether the ongoing call should have the packet discard policy applied comprises identifying a property of an air interface messaging sequence associated with the ongoing call.

18. A device for discarding packets within a cellular infrastructure comprising:
a receiver having an input;
a memory for storing a predetermined packet discard policy; and
a controller coupled to the receiver and the memory, the controller being programmed to receive a plurality of packets associated with a call at the input of the receiver, to identify whether the call is in need of application of the packet discard policy, to receive a trigger event at the input of the receiver and, responsively, to apply the packet discard policy to the call in order to selectively discard at least some of the plurality of packets associated with the call.

19. The device of claim 18 wherein the controller is further programmed to identify a property of at least one of the plurality of packets associated with the call.

20. The device of claim 18 wherein the controller is further programmed to identify a Quality-of-Service (QoS) type indication of the call.
